(19) United States
(12) Patent Application Publication
(10) Pub. No.: US 2010/0139707 A1
(43) Pub. Date: Jun. 10, 2010

(54) WASHABLE FILMIC LAMINATES

(75) Inventors: Lykele Jan Boonstra, Hoofdplaat (NL); Willem Marinus Stevels, Middelburg (NL); Richard Lane, Voorschoten (NL); Gert-Jan van Ruler, Middelburg (NL); Diana Wattel-Beenhouwer, Vlissingen (NL); Jacobus Gillis de Hullu, Wolphartsdijk (NL); Hakan Saxen, Nokia (FI)

Correspondence Address: POLLY C. OWEN, P.O. BOX 511, KINGSPORT, TN, 37662-5075, US

(73) Assignee: EASTMAN CHEMICAL COMPANY, Kingsport, TN (US)

(21) Appl. No.: 12/555,126

(22) Filed: Sep. 8, 2009

Related U.S. Application Data
(60) Provisional application No. 61/095,165, filed on Sep. 8, 2008.

(51) Int. Cl. B08B 3/00

(52) U.S. Cl. 134/29

(57) ABSTRACT

A process for removing a washable PSA laminate from a substrate is provided. The process comprises contacting the washable PSA laminate with water and optionally, a base, at a temperature sufficient to remove the washable PSA laminate from the substrate; wherein the washable PSA laminate comprises at least one facestock layer, at least one adhesive base layer, and at least one tackifier layer; wherein the facestock layer comprises at least one facestock material; wherein the adhesive base layer comprises at least one adhesive base polymer; wherein the tackifier layer comprises at least one tackifier and optionally at least one adhesive base polymer; wherein the tackifier layer is applied to the adhesive base layer side of the washable PSA laminate. Specifically, a process is provided for removing a washable PSA laminate from a bottle comprising contacting the washable PSA laminate with water and optionally, a base, at a temperature sufficient to remove the washable PSA laminate from the bottle.

### CROSS REFERENCE TO RELATED APPLICATIONS

This application claims priority to U.S. Provisional Application 61/095,165 filed Sep. 8, 2008, the disclosures of which are herein incorporated by reference in their entirety to the extent they do not contradict the statements herein.

### FIELD OF INVENTION

The present invention relates to washable PSA laminates that can be washed off of an article or substrate, such as returnable bottles for the beverage market. The washable PSA laminate comprises at least one facestock layer, at least one adhesive base layer, and at least one tackifier layer; wherein the facestock layer comprises at least one facestock material; wherein the adhesive base layer comprises at least one adhesive base polymer; wherein the tackifier layer comprises at least one tackifier and optionally at least one adhesive base polymer; and wherein the tackifier layer is applied to the adhesive base layer side of the washable PSA laminate.

### BACKGROUND OF THE INVENTION

In recent years, there is a growing trend towards pressure sensitive label adhesives that comprise clear filmic face materials, like e.g. polyethylene (PE) or oriented polypropylenes (OPP). These filmic label adhesives can be found in personal care labelling, such as shampoo bottles. Another segment that is driving towards filmic labelling is beverage labelling, like e.g. beer bottles and flavored alcoholic beverages. Particularly, beer bottlers have recognized the need to make their products more attractive to a broader market. Today's clear filmic labels enable bottlers to have a no-label look that is apparently more attractive to younger customers.

Traditionally, labels attached to beer bottles and other beverages comprising wet-glue adhesives and paper face-stock. A part of the beer bottle market is meant to be returnable for reuse, especially in the European and Russian market. Paper labels can easily be washed-off from the bottles in alkaline washing solutions at elevated temperatures, while the bottle is being cleaned simultaneously. In the case of paper labels water can easily penetrate through the paper facestock and reach the adhesive layer. Wet-glue adhesives are sensitive to water and consequently the label can be washed-off from the bottle.

Changing from paper to filmic face material has large consequences for the removal time of labels in washing solutions. Water is not able to penetrate through filmic face materials. Filmic face materials, like PE's and OPP's, are highly hydrophobic and therefore not susceptible to water. Water can therefore only penetrate into the adhesive through the filmic label edges. As a result, the time needed for complete removal of a conventional filmic label from the beer bottle in industrial bottle washers is unacceptably high.

In order to facilitate label removal during the washing process, other processes are needed. The present invention covers a process for utilizing a particular washable PSA laminate that is easily removed, particularly, when such laminates are placed and bottles and removed in industrial bottle washing equipment.

### SUMMARY OF THE INVENTION

In accordance with one embodiment of this invention, a process of removing a washable PSA laminate from an article comprising contacting the washable PSA laminate with water and optionally, a base, to remove the washable PSA laminate; wherein the washable PSA laminate comprises at least one facestock layer, at least one adhesive base layer, and at least one tackifier layer; wherein the facestock layer comprises at least one filmic facestock material; wherein the adhesive base layer comprises at least one adhesive base polymer; wherein the tackifier layer comprises at least one tackifier and optionally at least one adhesive base polymer; wherein the tackifier layer is applied to the adhesive base layer side of the washable PSA laminate.

### BRIEF DESCRIPTION OF THE DRAWINGS

FIG. 1 is a cross-section of a pressure sensitive adhesive laminate in one embodiment of the invention having an facestock layer (A), adhesive base layer (B), and tackifier layer (C).

FIG. 2 is a cross-section of a pressure sensitive adhesive laminate in another embodiment of the invention having an facestock layer (A), adhesive base layer (B), tackifier layer (C), and release layer (D).

FIG. 3 is a cross-section of a pressure sensitive adhesive laminate in another embodiment of the invention having an facestock layer (A), adhesive base layer (B), tackifier layer (C), and overlaminate layer (E).

FIG. 4 is a cross-section of a pressure sensitive adhesive laminate in another embodiment of the invention having an facestock layer (A), adhesive base layer (B), tackifier layer (C), and barrier layer (F).

FIG. 5 is a cross-section of a pressure sensitive adhesive laminate in another embodiment of the invention having an facestock layer (A), adhesive base layer (B), tackifier layer (C), overlaminate layer (E), and barrier layer (F).

FIG. 6 is a cross-section of a pressure sensitive adhesive laminate in another embodiment of the invention having an facestock layer (A), adhesive base layer (B), tackifier layer (C), release layer (D), and overlaminate layer (E).

FIG. 7 is a cross-section of a pressure sensitive adhesive laminate in another embodiment of the invention having an facestock layer (A), adhesive base layer (B), tackifier layer (C), release layer (D), and barrier layer (F).

FIG. 8 is a cross-section of a pressure sensitive adhesive laminate in another embodiment of the invention having an facestock layer (A), adhesive base layer (B), tackifier layer (C), release layer (D), overlaminate layer (E), and barrier layer (F).

FIG. 9 is a schematic overview of one embodiment of a process for preparing the PSA laminate according to the present invention.

FIG. 10 is a cross-section of a PSA laminate in another embodiment of the invention having a tackifier layer (C), an adhesive base layer (B), and an facestock layer (A) with a curved interface between (B) and (C).

FIG. 11 is a cross-section of a PSA laminate in another embodiment of the invention having a tackifier layer (C), an adhesive base layer (B), and an facestock layer (A) with a jagged interface between (B) and (C).

FIG. 12 is a cross-section of a PSA laminate in another embodiment of the invention having a tackifier layer (C), an adhesive base layer (B), and an facestock layer (A) with a discontinuous tackifier layer (C).

FIG. 13 is a cross-section of a PSA laminate in another embodiment of the invention having a tackifier layer (C), an adhesive base layer (B), and an facestock layer (A) with a discontinuous tackifier layer (C).

FIGS. 14.1-14.3 shows a simplistic illustration of the migration of the tackifier from tackifier layer (C) into the adhesive base layer (B) in one embodiment of the invention. FIG. 14.1 shows a cross-section of a PSA laminate in one embodiment of the invention having an facestock layer (A), an adhesive base layer (B), and a tackifier layer (C) prior to migration. FIG. 14.2 shows the migration of a portion of the tackifier in the tackifier layer (C) migrating into the adhesive base layer of the PSA laminate shown in FIG. 14.1. FIG. 14.3 shows the migration of all of the tackifier in the tackifier layer (C) into the adhesive base layer of the PSA laminate shown in FIG. 14.1.

### DETAILED DESCRIPTION OF THE INVENTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains to the extent they do not contradict the statements made herein.

The term “PSA” as used in this disclosure refers to an adhesive that will form a bond to two surfaces under light finger pressure at room temperature. The PSA provides enough potential deformability and wettability so that the necessary contact to a surface can be achieved, yet there is enough internal strength, or cohesion, within the adhesive for it to be able to resist any moderate separation forces. More information concerning the definition of a PSA can be found in Pressure Sensitive Adhesive Tapes, A Guide to Their Function, Design, Manufacture, and Use, John Johnston, Pressure Sensitive Tape Council, 2000, Chap. 2, p. 23.

The term “layer” when referring to the PSA laminate means a layer of material contained in the PSA that is of consistent thickness or can vary in thickness and can be either continuous or discontinuous depending on the use to be made of the PSA laminate. In addition, the composition and thickness of the PSA laminate can vary over time due to the migration of the tackifier in the tackifier layer (C) into the adhesive base layer (B).

The terms “migrate”, “migrating”, “migration”, “diffuse”, “diffusing”, and “diffusion” are used interchangeably and mean that a portion or all of the tackifier in the tackifier layer (C) moves into the adhesive base layer thereby producing a PSA laminate. As a result, the original adhesive base layer may swell, so that the thickness of the combined layers remains relatively unaffected.

The terms “washable PSA laminate” and “PSA laminate” mean a laminate comprising at least one facestock layer (Layer A), at least one adhesive base layer (Layer B), and at least one tackifier layer (Layer C); wherein the facestock layer comprises at least one facestock material; wherein the adhesive base layer comprises at least one adhesive base polymer; wherein the tackifier layer comprises at least one tackifier and optionally at least one adhesive base polymer; wherein the tackifier layer is applied to the adhesive base layer side of the washable PSA laminate.

In an embodiment of this invention, a process of removing a washable PSA laminate from a substrate comprising contacting the washable PSA laminate with water and optionally, a base, at a temperature sufficient to remove the washable PSA laminate from the substrate; wherein the washable PSA laminate comprises at least one facestock layer (Layer A), at least one adhesive base layer (Layer B), and at least one tackifier layer (Layer C); wherein the facestock layer comprises at least one facestock material; wherein the adhesive base layer comprises at least one adhesive base polymer; wherein the tackifier layer comprises at least one tackifier and optionally at least one adhesive base polymer; wherein the tackifier layer is applied to the adhesive base layer side of the washable PSA laminate.

The facestock layer (Layer A) comprises at least one facestock material. The facestock material can comprise any material that is known in the art to produce a PSA laminate. For example, the facestock material may be composed of such materials as paper (e.g. Kraft, bond, offset, litho, and sulfite paper) with or without sizing, or filmic polymers.

In one embodiment of the invention, the facestock layer comprises at least one filmic polymer. The facestock layer can contain a blend of filmic polymers or can be a multi-layer film of various filmic polymers. Filmic polymers include any filmic polymer that can be coextruded with the adhesive base polymer to produce the AB laminate. In one embodiment of the invention, it may be desired that the filmic polymer has a solubility parameter that is inconsistent with or incompatible with that of the adhesive base polymer to prevent migration between the two layers.

In another embodiment of the invention, the filmic polymer can, when combined with the adhesive base polymer, provide a sufficiently self-supporting construction to facilitate label separation and application. Alternatively, when the filmic polymer combined with the adhesive base polymer is not sufficiently self-supporting, an overlaminate layer can be applied to the exposed face of the facestock layer to provide additional stiffness. Preferably, the filmic polymer and any other material utilized in the facestock layer are chosen to provide the washable PSA laminate with the desired properties such as inter alia printability.

Typical filmic polymers include, but are not limited to, polystyrenes, polyolefins, polyvinylchlorides, polyamides, polyesters (e.g. polyethylene terephthalate, polylactic acid), polycarbonates, polyurethanes, polyacrylates, polyvinyl alcohols, functional polyesters (e.g. sulfopolyesters), poly(ethylene vinyl alcohols), polyether block polyamides, polyvinyl acetates, and mixtures thereof. Preferably, the filmic polymer is a polyolefin including, but not limited to, polymers having repeating units selected from the group consisting of ethylene, propylene, and 1-butene. In another embodiment, the filmic polymer is at least one selected from the group consisting of polyethylene, polypropylene and ethylene-propylene copolymer. Various polyethylenes can be utilized including low, medium, and high density polyethylenes. In another embodiment, the filmic polymer is a bi-axially oriented polypropylene (BOPP).

In one embodiment of the invention, the melt flow rate (MFR) of polyethylene used in the facestock layer can range from about 0.1 grams/10 minutes to about 15 grams/10 minutes measured at 190° C. using a 2.16 kg weight utilizing ASTM D1238, preferably from 0.1 grams/10 minutes to 5 grams/10 minutes. A commercial example of a polyethylene useful as the facestock layer is low density polyethylene sold as Lupolen 2426F having a density of about 0.924 g/cm³ using ISO 1183 test method and a melt flow rate of about 0.75 g/10 minutes following test method ISO 1133 obtained from Basell Polyolefins located in The Netherlands.

In another embodiment of the invention, the melt flow rate (MFR) of polypropylene used in the facestock layer can range from about 1 grams/10 minutes to about 20 grams/10 minutes measured at 230° C. using a 2.16 kg weight utilizing ASTM D1238, preferably from 0.1 grams/10 minutes to 10 grams/10 minutes. A commercial example of a polypropylene useful as the facestock layer is polypropylene homopolymer sold as Moplen HP422H having a density of 0.900 g/cm³ using ISO 1183 test method and a melt flow rate of about 2 g/10 minutes at 230° C. using a 2.16 kg weight following test method ISO 1133 obtained from Basell Polyolefins located in The Netherlands. A commercial example of a random polypropylene copolymer useful as the facestock layer is Moplen RP210M polypropylene having a density of 0.900 g/cm³ using ISO 1183 test method and a melt flow rate of about 6 g/10 minutes at 230° C. using a 2.16 kg weight following test method ISO 1133 obtained from Basell Polyolefins located in The Netherlands.

In one embodiment, when coextrusion is utilized to produce both the facestock layer (Layer A) and the adhesive base polymer layer (Layer B) to produce an AB laminate, the inner surface of the facestock layer may be coextruded with a barrier layer other than the barrier created by the adhesive base polymer layer (B) and/or the tackifier layer (C) of this invention. The barrier layer may prevent migration of constituents to the facestock layer. There may also be included, or alternatively provided, a tie or primer layer to enhance adhesion of the adhesive base polymer layer to the facestock layer. Moreover, “linerless” constructions are contemplated to be within the scope of the present claims. In linerless constructions, the outer surface is coated with a release material, such as a silicone (e.g., polydimethylsiloxane).

Generally, the facestock layer has a thickness that is suitable for the particular PSA laminate application. In one embodiment of the invention, the facestock layer has a thickness of about 10 μm to about 200 μm, preferably from about 20 μm to about 100 μm, and most preferably, from 30 μm to 90 μm. In one embodiment, the facestock layer is BOPP with a calliper of 50 μm. In yet another embodiment, the filmic polyer layer is polyethylene terepthalate (PET) with a caliper of 40 μm.

The adhesive base layer comprises at least one adhesive base polymer. The adhesive base polymer can be any that is known in the art that is suitable for producing a PSA laminate. Generally, the adhesive base polymer utilized to produce the PSA laminate may generally be classified into the following categories:

random copolymer adhesive base materials, such as, but not limited to, those copolymers based upon acrylate and/or methacrylate copolymers and their derivatives, α-olefin copolymers, silicone-copolymers, chloroprene/acrylonitrile copolymers, and the like;
block copolymer adhesive base polymers, such as, but are not limited to, those based upon linear block copolymers (e.g., A- [symbol] and AB-A type), multi-block copolymers, branched block copolymers, star block copolymers, grafted, or radial block copolymers, and the like; and
natural and synthetic rubber adhesive base polymers, such as, but are not limited to, polyisobutylene, polyisoprene, butyl rubber, and the like.

In another embodiment of the invention, examples of copolymers based upon acrylate and/or Methacrylate copolymers and their derivatives, but are not limited to, 2-ethyl hexyl acrylate, butyl acrylate, methyl (meta)acrylate, acrylic acid, styrene and mixtures thereof. In one embodiment of the present invention, the adhesive base polymer is an acrylic polymer comprising primarily 2-ethylhexyl acrylate.

In another embodiment of the invention, the adhesive base polymer comprises a thermoplastic elastomer (TPE). Thermoplastic elastomers are polymers that behave like a rubber at their use temperature, but can be processed in the melt as conventional polymers. TPEs include, but are not limited to, linear, branched, graft or radial block copolymers.

Block copolymers can be represented by a di-block structure A-B, a tri-block A-B-A structure, a tetra-block structure, a multi-block structure, a radial or coupled structure (A-B)n, and combinations of these structure; wherein A represents a hard thermoplastic phase or block which is non-rubbery or glassy or crystalline at room temperature but fluid at high temperatures, and B represents a soft-block which is rubbery or elastomeric at service or room temperatures. These thermoplastic elastomers may comprise from about 75% to about 95% by weight of rubbery segments and from about 5% to about 25% by weight of non-rubbery segments.

The non-rubbery segments or hard blocks comprise polymers of mono- and poly-cyclic aromatic hydrocarbons, and more particularly vinyl-substituted aromatic hydrocarbons which may be mono-cyclic or bi-cyclic in nature. The preferred rubbery blocks or segments comprise polymer blocks of homopolymers or copolymers of aliphatic conjugated dienes. Rubbery materials, such as, but not limited to, polyisoprene, polybutadiene, and styrene butadiene rubbers may be used to form the rubbery block or segment. Particularly preferred rubbery segments include polydienes, and rubbers of ethylene-butylene or ethylene-propylene copolymers. The latter rubbers may be obtained from the corresponding unsaturated polyalkylene moieties such as polybutadiene and polyisoprene by hydrogenation thereof.

In one embodiment of the invention, the block copolymer may be selected from the group consisting of butadiene-based polymers, isoprene-based polymers, polyether block polyamides, and mixtures thereof. Thus, the butadiene-based polymers may be selected from the group consisting of styrene-butadiene-styrene (SBS) block copolymers, styrene-butadiene (SB) block copolymers, multi-armed (SB)ₓ block copolymers, polybutadiene block copolymers, and mixtures thereof. Isoprene-based copolymers may be selected from the group consisting of styrene-isoprene-styrene (SIS) block copolymers, styrene-isoprene-butadiene-styrene (SIBS) copolymers, styrene-isoprene (SI) block copolymers, linear and multi-armed (SI)ₓ block copolymers, radial block copolymers having an styrene-ethylene-butadiene-styrene (SEBS) backbone and isoprene and/or styrene-isoprene (SI) arms, polyisobutylene, natural rubber, synthetic polyisoprene, and mixtures thereof.

Specific examples of di-block copolymers include, but are not limited to, styrene-butadiene (SB), styrene-isoprene (SI), and the hydrogenated derivatives thereof. Examples of tri-block polymers, tetra-block polymers, and multi-block polymers include, but are not limited to, styrene-butadiene-styrene (SBS), styrene-isoprene-styrene (SIS), α-methylstyrene-butadiene-α-methylstyrene, α-methylstyrene-isoprene-α-methylstyrene, styrene-isoprene-butadiene-styrene (SIBS) and derivatives thereof. Upon hydrogenation of SBS copolymers comprising a rubbery segment of a mixture of 1,4- and 1,2-isomers, a styrene-ethylene-butylene-styrene (SEBS) block copolymer is obtained. Similarly, hydrogenation of an SIS polymer yields a styrene-ethylene/propylene-styrene (SEPS) block copolymer and hydrogenation of a (SI)ₓ multiblock copolymer provides a multiblock copolymer of styrene and ethylene/propylene (SEP)ₓ.

It is contemplated that functionalized block copolymers can be used, such as succinic anhydride-modified SEBS, which is commercially available as Kraton FG-1901X and 1924X block copolymer from Kraton Polymers in Houston, Tex.

It should be noted that any of the adhesive base polymers include the hydrogenated derivatives thereof. A number of selectively hydrogenated block copolymers are available commercially from Kraton Polymers under the general trade designation “Kraton G”. Thus, particularly suitable block copolymers for the purposes of the present invention include Kraton G 1657 and Kraton G 1730 block copolymers. Kraton G 1657 is a SEBS tri-block copolymer which contains about 13% by weight styrene. Kraton G 1730 is a (SEP)ₓ multi-block copolymer which contains about 21% by weight styrene.

Moreover, the adhesive base polymer layer (B) can be made up of high cohesive strength polymers. Since such polymers require relatively high temperatures to process in traditional hot melt manufacturing equipment, they are typically not used in producing a PSA laminate from the melt since at high temperatures, the tackifiers do not withstand such temperatures over an extended period of time. Such high cohesive strength polymers may also be applied with the tackifier in the tackifier layer (C) as either a solution or dispersion. Examples of high cohesive strength polymers include, but are not limited to, styrene block copolymers and isobutylene copolymers. Styrene block copolymers include, but are not limited to, styrene-isoprene-styrene block copolymers and copolymers based on styrene and ethylene/butylene (S-E/B-S), and copolymers based on styrene and ethylene/propylene (S-E/P-S). In one embodiment of the invention, the polystyrene content of the SIS block copolymer ranges from about 10% by weight to about 50% by weight, preferably from 15% by weight to 30% by weight. In another embodiment of the invention, the solution viscosity of the styrene block copolymers ranges from about 0.05 Pa·s to about 20 Pa·s, preferably from 0.1 Pa·s to 5 Pa·s measured utilizing 25% solids in toluene in a Brookfield viscosimeter, such as a Brookfield viscosimeter type DV-I+, using an appropriate spindle and rotation speed.

In another embodiment of the invention, the molecular weight of the polyisobutylene ranges from about 250,000 to about 5,000,000, preferably from 750,000 to 3,500,000. High cohesive strength polymers are commercially available as Kraton D1111 styrene-isoprene-styrene polymers from Kraton Polymers in Houston, Tex., Oppanol B200 isobutylene copolymers available from BASF, Ludwigshafen, Germany, and Kraton G-1652E S-E/B-S copolymer from Kraton Polymers.

Further examples of useful adhesive base polymers can be found in WO 00/13888, WO 00/17285, and WO 01/96488, incorporated by reference herein in their entirety to the extent they do not contradict the statements herein.

In one embodiment of the invention, the typical coating weight of the adhesive base polymer is less than 50 gsm, less than 30 gsm, or from 5 gsm to 20 gsm. In one embodiment of the present invention, the coating weight of the base polymer layer is about 17 gsm. In another embodiment of the present invention, the coating weight is about 9 gsm.

Generally, the adhesive base layer has a thickness that is suitable for the particular PSA laminate application. In one embodiment of the invention, the adhesive base layer has a thickness of about 1 μm to about 60 μm, preferably from about 2 μm to about 40 μm, and most preferably, from 4 μm to 20 μm.

The adhesive base layer can be modified by the addition of additives. Any additive known in the art that is compatible with the adhesive base polymer can be utilized. In one embodiment of the invention, the adhesive base layer can be modified with pure monomer resins; poly(ethylene) or poly(propylene) waxes; poly(ethylene) with low viscosity, such as polyethylene with a melt flow rate of about 5 g/10 min to about 80 g/10 min, preferably 10 to 50 g/10 min, 190° C., 2.16 kg weight, according to ASTM D-1238; and ethylene or propylene based (co)polymers as produced by metallocene catalysts. These additives can be utilized to improve the unwind characteristics of the AB laminate formed by the facestock layer and the adhesive base layer and/or to facilitate the production of the AB laminate formed by the facestock layer and the adhesive base layer by matching the rheological properties of the filmic polymer and the adhesive base polymer.

The tackifier layer (C) comprises at least one tackifier. In one embodiment, the tackifier layer (C) comprises at least one tackifer and at least one polymer. In another embodiment, the tackifier layer (C) comprises at least one tackifier, at least one polymer, and at least one plasticizer.

The polymer can be any polymer known in the art suitable for producing PSA laminates. Preferably, the polymer is at least one thermoplastic elastomer. Thermoplastic elastomers were previously discussed in this disclosure. The polymer can be any polymer known in the art suitable for producing PSA laminates. Preferably, the polymer is at least one thermoplastic elastomer. Thermoplastic elastomers were previously discussed in this disclosure. In one embodiment of the invention, the amount of polymer is that which does not cause the tackifier layer to be a PSA. The amount of polymer can range from 0.1% by weight to about 15% by weight. Other ranges can be selected from the following ranges which are given in weight percent based on the weight of the tackifier layer (C): 0 to 7, 0 to 9, 0.1 to 15; 1 to 15, 5 to 15, 10 to 15, 0.1 to 10, 1 to 10, 5 to 10, 7 to 10, 0.1 to 5, 1 to 5, and 2 to 5.

The tackifier can be any that is known in the art suitable for use in PSA laminates. The tackifer can include, but is not limited to, amorphous tackifier resins of all types known to tackify adhesives, including rosin-based and hydrogenated rosin-based, hydrocarbon-based and hydrogenated hydrocarbon-based, phenolic-based, terpene-based, terpene phenolic-based, styrenated terpene-based, hydrogenated terpene-based, polyester-based, pure monomer aromatic-based, aromatic acrylic-based, liquid resin types, and functionalized types thereof. Note that any of these tackifiers may be in a hydrogenated form. Pure monomer aromatic-based tackifier are tackifying resins based on low molecular weight polymers or oligomers produced from monomers, such as, for example, styrene, alpha-methylstyrene, vinyl toluene, and mixtures thereof.

Rosin-based and hydrogenated rosin-based tackifiers include rosin esters. Examples of rosin esters include, but are not limited to, rosin esters of tri-ethylene glycol, glycerol, pentaerithrytol, and mixtures thereof. The natural source of rosin esters include, but is not limited to, gum rosin, wood rosin, and tall oil rosin, or mixtures thereof. Rosin esters are available as Permalyn 5095 (glycerol ester of rosin) or Permalyn 5110 (pentaerithrytol ester of rosin) from Eastman Chemical Company in Kingsport, Tenn. In one embodiment of the present invention, the tackifier is a hydrogenated rosin ester derived from glycerol and gum rosin, which is commercially available as Foral 85-E from Eastman Chemical Company in Kingsport, Tenn.

In one embodiment of the invention, the tackifier layer comprises a liquid tackifier composition. The liquid tackifier composition may be a solution or dispersion of an appropriate tackifier. Such tackifier may be selected on the basis of experiments or existing knowledge with regard to the composition of the pressure sensitive adhesive laminate based on the adhesive base polymer being the major component of the PSA laminate.

In another embodiment of this invention, the tackifier layer (C) may be a blend of polymer (i.e. adhesive base polymer and/or other performance additives) and amorphous resin tackifier resulting in a tackifier masterbatch composition. This composition can be formulated for spray ability/high-tack/adhesion and good compatibility with the adhesive base polymer layer.

Optionally, the tackifier layer can further comprise at least one plasticizer. The plasticizer can be any that is known in the art suitable for use in a PSA laminate. Examples of plasticizers include, but are not limited to, naphthenic and paraffinic oils, citrates, sulfonates, and phthalates

Tackifiers may vary in their compatibility with the adhesive base polymer. In one embodiment of the invention, the tackifier may be preferentially soluble in the adhesive base polymer. This is especially suitable for elastomers containing polystyrene or polyisoprene blocks. Tackifiers that are preferentially soluble in polystyrene and polyisoprene are obtained by polymerization of a stream of aliphatic petroleum derivatives in the form of dienes and mono-olefins containing 5 or 6 carbon atoms, generally in accordance with the teachings of U.S. Pat. No. 3,577,398, herein incorporated by reference in its entirety to the extent it does not contradict statements herein. The resulting hydrocarbon resins range from materials that are normally liquid at room temperatures to materials that are normally solid at room temperature, and typically contain 40% or more by weight polymerized dienes. Such dienes may be, for example, piperylene and/or isoprene. Examples include, but are not limited to, the Piccotac® family of resins (available from Eastman Chemical Company, Kingsport, Tenn., USA) and the Wingtack® family of resins (available from the Chemical Division of Goodyear Tire and Rubber Company, Akron, Ohio). Other solid tackifiers include, but are not limited to, Escorez® 1304 and Escorez® 1310-LC manufactured by Exxon Chemical Company (Houston, Tex.). Further examples include, but are not limited to, modified C₅-type petroleum resins which are made by copolymerizing one or more C₅ monoolefins and/or diolefins with one or more C₈ or C₉ monoalkenyl aromatic hydrocarbons. These modified C₅-type petroleum resins can be hydrogenated. Examples include, but are not limited to, C₅ monoolefins and diolefins such as isoprene, 2-methyl-1-butene, 2-methyl-2-butene, cyclopentene, 1-pentene, cis- and trans-2-pentene, cyclopentadiene, and cis-trans-1,3-pentadiene. Additional examples of C₈ and C₉ monoalkenyl aromatic compounds are styrene, methylstyrene, and indene.

Other compositions that can be used as tackifiers include, but are not limited to, hydrogenated aromatic resins in which a substantial portion (50% or greater), if not all, of the benzene rings are converted to cyclohexane rings (for example the Regalite™ and Regalrez™ family of resins available from Eastman Chemical, such as, Regalite R 1090, R 1100, R 1125, R 7100, R 9100 and Regalrez 1018, 1094, 3102, 6108, and 1126) and hydrogenated polycyclic resins (typically dicyclopentadiene resins, such as Escorez® 5300, 5320, 5340, 5380, 5400 and 5600, manufactured by Exxon Chemical Company). These tackifiers are especially useful when using an isoprene-based adhesive base polymer.

In another embodiment of the invention, one may further add rosins, rosin esters, polyterpenes, aromatic and functionalized resins and other tackifiers to the tackifier layer (C) that are compatible to some degree with the adhesive base polymer contained in the adhesive base layer, especially when utilizing polyisoprene or polybutadiene as the adhesive base polymer. Other additives include, but are not limited to, plasticizer oils, such as Shell Flex 371 (from Shell Chemical Company).

In one embodiment, the tackifier layer (C) contains at least one tackifier in an amount of about 50% to about 90% by weight, preferably 70% to 90% by weight, either as a solution or a dispersion. In another embodiment, the tackifier layer (C) comprises a blend of the thermoplastic elastomer, which is present in the AB laminate, and an amorphous resin tackifier. Preferably, the tackifier layer (C) includes about 2% to about 15% by weight of a thermoplastic elastomer, which may be the same elastomer as present in the adhesive base layer (B) or an elastomer compatible therewith.

In one embodiment of the invention, the amount of tackifier in the tackifier layer (Layer C) is from about 20% to 100% by weight, or from about 30% to 90% by weight, or from 40% to 70% by weight based on the weight of the tackifier layer. In one embodiment, the amount of tackifying resin present in the adhesive composition is 67.5% by weight. In another embodiment, the amount of tackifying resin present in the adhesive composition is 45% by weight.

Generally, the tackifier layer (C), comprising at least one tackifier has a coating weight that is suitable for the particular washable PSA laminate application. Typically the coating weight is from about 2 gsm to about 50 gsm, from about 4 gsm to about 30 gsm, or from 5 gsm to 20 gsm.

Generally, the tackifier layer has a thickness that is suitable for a particular PSA laminate application. In one embodiment of the invention, the tackifier layer has a thickness of about 2 μm to about 150 μm. Other ranges are from about 4 to about 125 μm and from 5 μm to 50 μm.

The tackifier layer can be applied to the AB laminate by any method known in the art. The tackifier is applied to the adhesive base polymer layer (B) side of the PSA laminate. Examples of application methods utilizing heat include, but are not limited to, slot die coating, roll axis coating, curtain coating, knife-over-roll coating, and spray coating. The tackifier layer can also be applied as an emulsion, dispersion or solution of the tackifier composition by any suitable method.

Depending on the use of the PSA laminate, the tackifier layer (C) itself may or may not form an effective PSA layer for the purposes of a PSA laminate (e.g. label, etc.). The term “PSA” was previously defined in this disclosure. In other words, if a tackifier layer (C) does not form an effective PSA layer when it is applied to a solid substrate neither the adhesive nor the structural properties (tack and strength) would be sufficient to form a structure (including an adhesive bond) with the properties of a conventional pressure sensitive adhesive laminate.

The facestock layer, adhesive base layer, and tackifier layer of the PSA laminate can contain inorganic fillers and other organic and inorganic additives to provide desired properties, such as, but not limited to, appearance properties (opaque or coloured films), durability, and processing characteristics. Examples of useful fillers include, but are not limited to, calcium carbonate, titanium dioxide, metal articles, and fibers. Additives can include, but are not limited to, flame retardants, antioxidant compounds, heat stabilizers, light stabilizers, ultra-violet light stabilizers, anti-blocking agents, processing aids, and acid acceptors, etc. Nucleating agents can be added to increase crystallinity and thereby increase stiffness.

The adhesive base polymer layer (B) and tackifier layer (C), according to the present invention, include, but is not limited to water-based, solvent-based, hotmelt-based, and UV-crosslink systems.

In one embodiment of the present invention the adhesive base polymer layer (B) is water-based, and the tackifier layer (C) is hotmelt based. In another embodiment of the present invention, the adhesive base polymer and tackifier composition are both water-based.

The adhesive base polymer can be coated by any method known in the art. Methods include, but are not limited to, co-extruded, blown- or cast-film processes, or extrusion coated, or deposited from a water based emulsion. The tackifier composition can be coated from the melt, or deposited from a water based emulsion.

According to the present invention, various coating heads known to the art for producing PSA laminates can be utilized, such as, but not limited to, knife over roll, slot-die, curtain coating, and gravure coating heads.

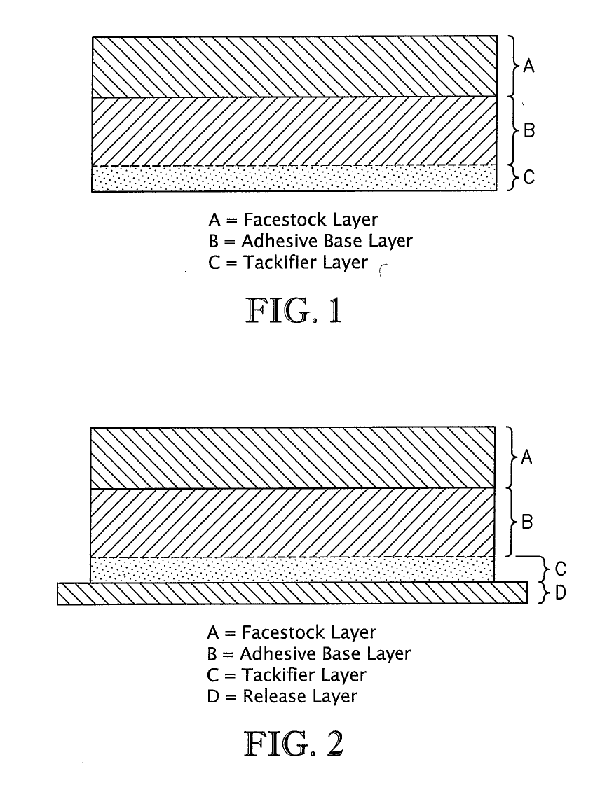

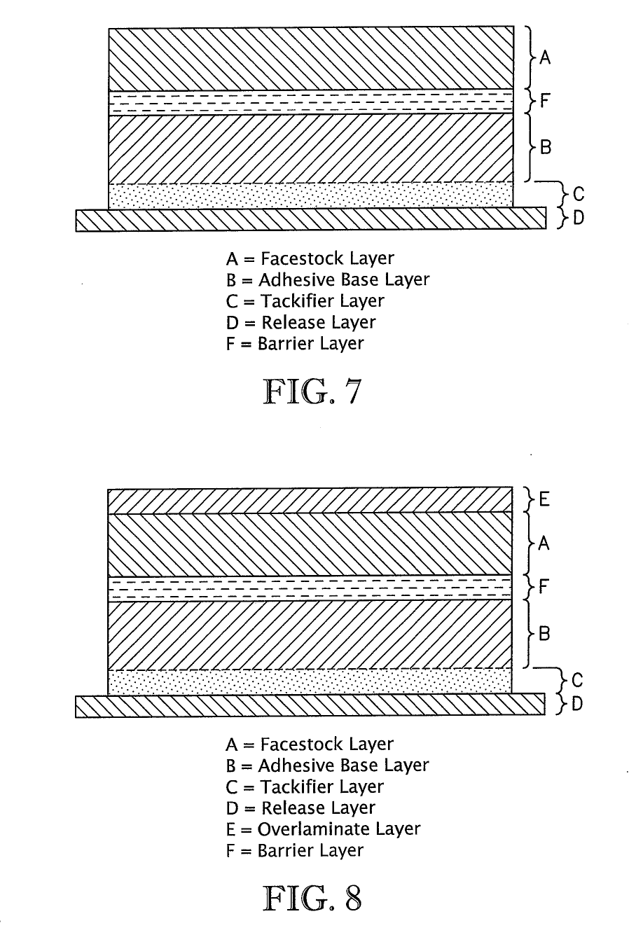

Particular embodiments of the PSA laminate are shown in FIGS. 1-8 and 10-14. The PSA laminates in FIGS. 1-8 and 10-14 illustrate embodiments of the invention where the tackifier in the tackifier layer (C) has not yet migrated into the adhesive base layer (B). The coextruded melt bond (10) between the facestock layer and the adhesive base layer is shown in each figure.

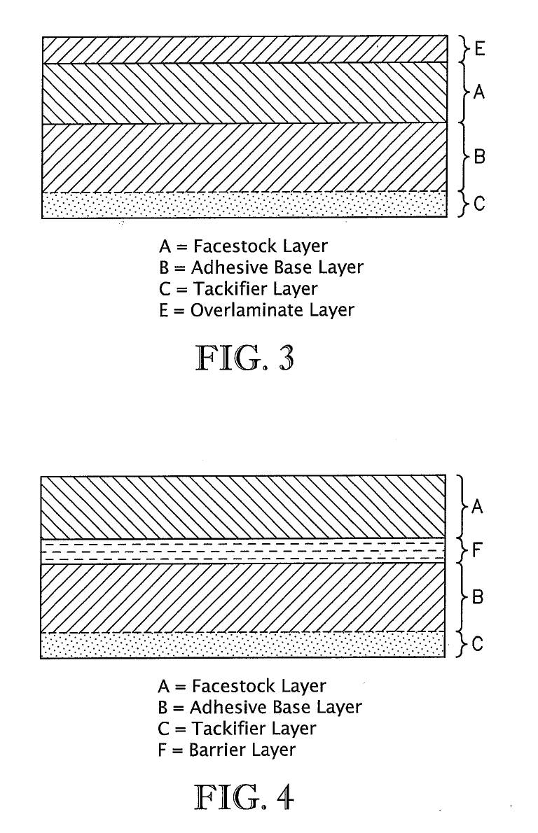

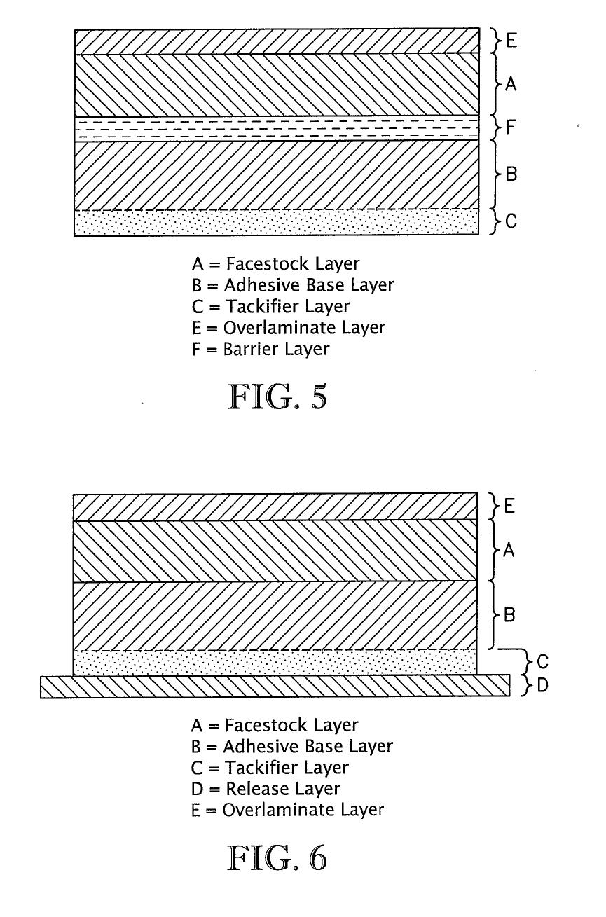

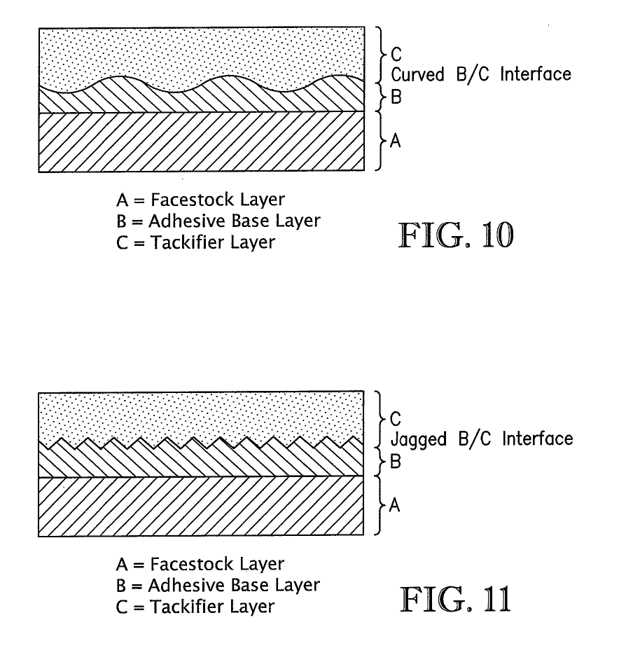

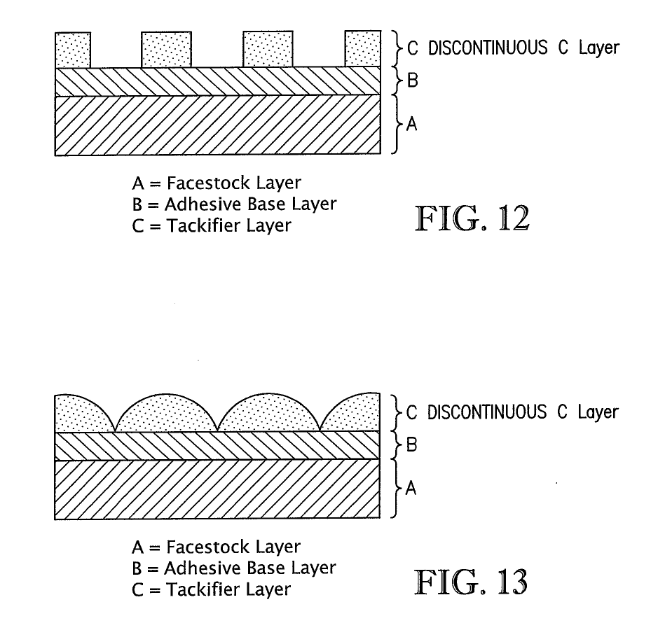

In FIG. 1, a cross-section of a PSA laminate is shown comprising an facestock layer (A), an adhesive base layer (B), and a tackifier layer (C). In FIG. 2, a cross-section of a PSA laminate further comprising a release layer (D) is shown. In FIG. 3, a cross-section of a PSA laminate comprising an facestock layer (A), an adhesive base layer (B), a tackifier layer (C), and an overlaminate layer (E) is shown. In FIG. 4, a cross-section of a PSA laminate of FIG. 1 is shown further comprising a barrier layer (F) between the facestock layer (A) and the adhesive base layer (B). In FIG. 5, a cross-section of a PSA laminate is shown comprising an facestock layer (A), an adhesive base layer (B), a tackifier layer (C), an overlaminate layer (E), and a barrier layer (F). FIGS. 6-8 show the PSA laminates of FIGS. 3-5 further comprising a release layer (D). Layers A-F have been previously described in this disclosure. In FIG. 10, a cross-section of a PSA laminate is shown having a tackifier layer (C), an adhesive base layer (B), and an facestock layer (A) wherein there is a curved interface between (B) and (C). In FIG. 11, a cross-section of a PSA laminate is shown having a tackifier layer (C), an adhesive base layer (B), and an facestock layer (A) wherein there is a jagged interface between (B) and (C). In FIG. 12, a cross-section of a PSA laminate is shown having a tackifier layer (C), an adhesive base layer (B), and an facestock layer (A) wherein there is a discontinuous tackifier layer (C). In FIG. 13, a cross-section of a PSA laminate is shown having a tackifier layer (C), an adhesive base layer (B), and an facestock layer (A) wherein there is a discontinuous tackifier layer (C).

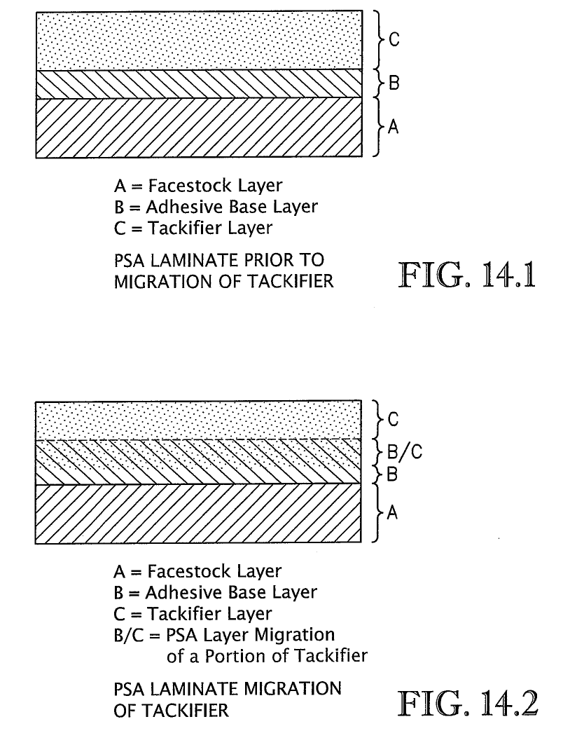

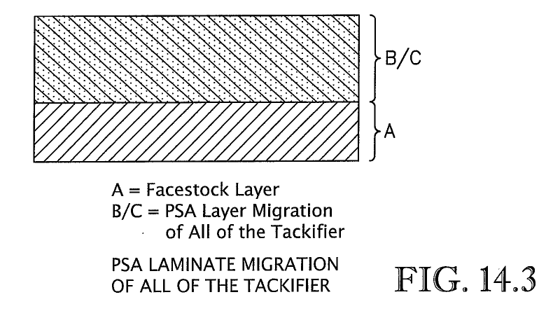

Although not intended to be bound by theory, FIGS. 14.1-14.3 shows a simplistic illustration of the migration of the tackifier from tackifier layer (C) into the adhesive base layer (B) in one embodiment of the invention. FIG. 14.1 shows a cross-section of a PSA laminate in one embodiment of the invention having an facestock layer (A), an adhesive base layer (B), and a tackifier layer (C) prior to migration. FIG. 14.2 shows the migration of a portion of the tackifier in the tackifier layer (C) migrating into the adhesive base layer of the PSA laminate shown in FIG. 14.1 to produce a PSA layer (B/C). FIG. 14.3 shows the migration of all of the tackifier in the tackifier layer (C) into the adhesive base layer of the PSA laminate shown in FIG. 14.1 to produce a PSA layer (B/C).

Typically, the PSA laminate can have a thickness of about 35 to about 400 μm, preferably about 100 μm to about 250 μm, and most preferably from 50 μm to 150 μm. Generally, the PSA laminate can have a thickness ratio of facestock layer (A) to adhesive base layer (B) from about 50:1 to about 1:1, preferably 25:1 to 2:1. Thus, the thickness of facestock layer (A) may be in the range from about 10 μm to about 200 μm, preferably from about 20 μm to about 100 μm, and most preferably from 30 μm to 90 μm. Adhesive base layer (B) may have a thickness of about 1 to about 60 μm, preferably about 2 to about 40 μm and most preferably, 4 to 20 μm. A particularly suitable PSA laminate may have a thickness of 50-150 μm.

The AB laminate can be produced by any method known in the art of contacting the facestock layer (A) and the adhesive base layer (B). For example, the facestock layer (A) and the adhesive base layer (B) can be contacted by coextrusion, solvent-coating, and emulsion coating.

In one embodiment of the invention, the AB laminate is formed by a process comprising co-extruding an facestock layer (A) comprising at least one filmic polymer and an adhesive base polymer layer (B) comprising at least one adhesive base polymer, which may later on in the process be converted into a pressure sensitive adhesive laminate. The co-extrusion can be conducted by any method known in the art. Examples of processes for co-extruding the facestock layer (A) and the adhesive base layer (B) include, but is not limited to, casting and bubble blowing. In one embodiment, the co-extrusion can be conducted by melting the filmic polymer and non-adhesive polymer in separate extruders and delivering the molten streams to an extrusion die from which the facestock layer (A) and the adhesive base layer (B) are extruded.

The co-extrusion of the filmic polymer with the adhesive base polymer may be facilitated when the melt viscosities of the two polymers are similar. Thus, the choice of the material to be utilized in the formation of the AB laminate may depend upon the melt flow rate of the coextruded materials. In one embodiment of the invention when the filmic polymer is polyethylene, the melt flow rate of the filmic polymer can range from about 0.1 g/10 min to about 15 g/10 min, preferably from 0.1 g/10 min to 5 g/10 min at 190° C. using a 2.16 kg weight (ASTM D1238). In one embodiment of the invention when the filmic polymer is polypropylene, the melt flow rate of the filmic polymer can range from about 1 g/10 min to about 20 g/10 min, preferably from 0.1 g/10 min to 10 g/10 min at 230° C. using a 2.16 kg weight (ASTM D1238).

The AB laminate has a thickness that is suitable for the particular application sought. In one embodiment of the invention, the AB laminate has a thickness of about 10 μm to about 260 μm, preferably from about 20 μm to about 140 μm, and most preferably, from 30 μm to 80 μm. The thickness of the facestock layer can range from about 10 μm to about 200 μm, preferably from about 20 μm to about 100 μm, and most preferably, from 30 μm to 90 μm. The thickness of the adhesive base layer can range from about 1 μm to about 60 μm, preferably from about 2 μm to about 40 μm, and most preferably, from 4 μm to 20 μm. The ratio of the facestock layer to the adhesive base layer can range from 50:1 to 1:1, preferably from 25:1 to 2:1 and most preferably, 15:1 to 4:1.

Optionally, a number of additional steps can be performed on the AB laminate or PSA laminate. Thus, for example, the AB laminate or PSA laminate may be uniaxially or biaxially oriented (e.g., by heat stretching and heat setting). In this context, it is appreciated that the application of the tackifier layer (C) may be effected both before and/or after the stretching occurs. Machine direction or biaxial orientation of the AB laminate or PSA laminate according to the invention can be accomplished by techniques known in the art. For example, the laminates can be oriented in the machine direction by using tentering frames.

The adhesive base polymer of the adhesive base layer in the co-extrusion process can establish/form a coextruded melt bond with the facestock layer. Thus, any off-setting that can occur with a normally manufactured, transfer coated, hot melt PSA filmic label can be eliminated. Off-setting is the undesirable transfer of adhesive to a substrate during label removal caused by insufficient anchorage of the adhesive layer onto the filmic layer substrate.

In one embodiment of the present invention, an AB laminate is provided having a thickness of about 11 to about 210 μm comprising:
a. at least one facestock layer comprising at least one filmic polymer and having a thickness of about 10 to about 160 μm, preferably 45 to 150 μm, and
b. at least one adhesive base layer having a thickness of about 1 to about 50 μm comprising at least one thermoplastic elastomer (TPE) selected from the group of TPEs which are capable of forming a pressure sensitive laminate.

The AB laminate may further comprise an anti-blocking layer having a thickness of about 1 to about 5 μm on top of the facestock layer (i.e. not in contact with the adhesive base layer (B)). This optional anti-blocking layer may typically be coextruded with the facestock layer (A) and the adhesive base layer (B). The purpose of this layer is to provide a smoother release or unwind of a rolled up AB laminate during the coating of the tackifier layer (C).

In one embodiment of the invention, the thermoplastic elastomer and the thickness of the adhesive base layer typically will be selected on the basis of two criteria: (a) strength requirements of the PSA laminate, and (b) capability of the thermoplastic elastomer to form a traditional PSA composition when about 30% to about 95% by weight of the thermoplastic elastomer and about 5% to about 70% by weight of a tackifier are combined (e.g. hot melt) and applied as a tackifier layer (C) to the AB laminate. In this context, it should be kept in mind that it is the purpose and function of the adhesive base polymer layer to “receive” the tackifier layer (C). Thus, the adhesive base polymer layer typically comprises no tackifier.

In forming the PSA layer (B and C) by applying a tackifier layer (C), a portion of the tackifier can diffuse into the adhesive base layer (B) such that a molecular weight gradient from tackifier layer (C) (low molecular weight) to adhesive base layer (B) (high molecular weight) will form. This leaves a low molecular weight, high-tack layer at the surface of (C) exactly where this functionality is required to create pressure sensitive bonds. Conversely, in the high molecular weight portion of the PSA layer (B & C), enhanced and improved shear resistance, creep resistance and high temperature performance may be observed.

In one embodiment of the invention, the portion of tackifier that diffuses into the adhesive base layer can be selected from the following ranges which are given in weight percent based on the weight of the tackifier layer (C): 0.1 to 100; 5 to 100; 10 to 100; 15 to 100; 20 to 100; 25 to 100; 30 to 100; 35 to 100; 40 to 100; 50 to 100; 55 to 100; 60 to 100; 65 to 100; 70 to 100; 75 to 100; 80 to 100; 85 to 100; 90 to 100; 95 to 100; 0.1 to 90; 5 to 90; 10 to 90; 15 to 90; 20 to 90; 25 to 90; 30 to 90; 35 to 90; 40 to 90; 45 to 90; 50 to 90; 55 to 90; 60 to 90; 65 to 90; 70 to 90; 75 to 90; 80 to 90; 85 to 90; 0.1 to 80; 5 to 80; 10 to 80; 15 to 80; 20 to 80; 25 to 80; 30 to 80; 35 to 80; 40 to 80; 45 to 80; 50 to 80; 55 to 80; 60 to 80; 65 to 80; 70 to 80; 75 to 80; 0.1 to 70; 5 to 70; 10 to 70; 15 to 70; 20 to 70; 25 to 70; 30 to 70; 35 to 70; 40 to 70; 45 to 70; 50 to 70; 55 to 70; 60 to 70; 65 to 70; 0.1 to 60; 5 to 60; 10 to 60; 15 to 60; 20 to 60; 25 to 60; 30 to 60; 35 to 60; 40 to 60; 45 to 60; 50 to 60; 55 to 60; 0.1 to 50; 5 to 50; 10 to 50; 15 to 50; 20 to 50; 25 to 50; 30 to 50; 35 to 50; 40 to 50; 45 to 50; 0.1 to 40; 5 to 40; 10 to 40; 15 to 40; 20 to 40; 25 to 40; 30 to 100; 35 to 40; 0.1 to 30; 5 to 30; 10 to 30; 15 to 30; 20 to 30; 25 to 30; 0.1 to 20; 5 to 20; 10 to 20, 15 to 20; 0.1 to 10; and 5 to 10.

The PSA laminate can be produced by any method known in the art. In one embodiment of the invention, the PSA laminate can be produced in a one-step extrusion/spray-coating process, and the obtained PSA laminate may be self-wound or laminated to a release liner (e.g. silicone backing paper) and wound, creating PSA tape or label structures, respectively. Such PSA laminate will thus be created cost-effectively. In particular, the tackifier layer (C) can be coated at very low temperatures, typically up to 100° C. lower than with traditional hot-melt pressure sensitive adhesives. This may improve the manufacturing process in at least one of the following ways: (1) heat sensitive facestock layers, e.g. polyethylene, may be direct coated compared to the usual method of transfer coating; (2) process costs are lower; (3) a tackifier master-batch composition may be expected to have better heat aging properties, less colour loss, less charring in comparison to PSA laminates that have been conventionally processed or coated at high temperatures (with the tackifier in the PSA composition) which can exhibit gelling and/or charring due to an extended heat history.

It can be particularly advantageous to “assemble” the final PSA laminate at a different location from the production facility for the manufacture of the AB laminate. The AB laminate can be self-wound and stored for an indefinite time. In a second process step, the AB laminate (A & B) can then be further processed, for example, on a (narrow web) label press which is suitably modified for spraying or coating of the tackifier layer (C) onto the AB laminate to form the pressure sensitive adhesive layer (B and C), thereafter laminated with off-line produced release paper or release film (D), where the finished label would then be processed and used as a traditionally manufactured label laminate. To further reduce the costs, it is envisaged that such process could take place in-line with the printing and converting of the label where the finished label would then be applied directly to the article to be labelled. This would obviate the need for a silicone backing support and would further reduce the costs.

The conversion of the AB laminate can be effected either in one production line (on-line) or off-line at a different location. This conversion typically will be implemented by applying the tackifier layer (C) to the second surface (or under surface) of the AB laminate (i.e. that is the surface of the AB laminate that is not in contact with the facestock layer (A)). Tackifier layer (C) may be applied on the adhesive base layer (B) either directly or indirectly. In an indirect (or transfer) coating process, tackifier layer (C) may be first coated on an intermediary carrier (e.g. siliconized paper) and then transferred to adhesive base polymer layer (B).

In one embodiment of the invention, the tackifier is a liquid or has been liquified (by melting, adding of solvent, forming of dispersion). Suitable solvents include hydrocarbons such as toluene. Dispersions may be formed with water and/or alcohols. Thus, the present invention further suggests tackifier compositions which essentially comprise one of the previously described tackifiers with either a solvent or dispersant and other additives.

In general, a PSA laminate according to the invention can have a thickness of about 35 to about 400 μm, from 100 to 200 μm, or from 40 to 80 μm. However, other laminates are contemplated to be within the scope of the invention. e.g. faceless PSA constructions as described in US 2003198737, herein incorporated by reference to the extent it does not contradict statements herein. Accordingly, in applying the tackifier layer (C), both the layer thickness to be applied to the AB laminate and the concentration of the tackifier in the layer are of some concern.

The ranges for tackifier concentration in the tackifier layer (C) and the thickness were discussed previously in this disclosure. Thus, one function of the tackifier layer (C) is to provide a reservoir or source for a tackifier to migrate into the adhesive base layer to form the PSA laminate. An additional concern is the choice of solvent/dispersant, which on the one hand, could facilitate the migration of the tackifier into the adhesive base polymer layer, but on the other hand, should not be present in an amount to effectively swell the adhesive base polymer layer.

In one embodiment of the invention, the tackifier layer (C) itself does not form a PSA. The term “PSA” was previously defined in this disclosure. In this embodiment, both the concentration of the tackifier and the viscosity of the tackifier (which can account for the easiness of the application of the tackfier composition to the adhesive base layer) would be insufficient to form an effective pressure sensitive adhesive laminate.

In another embodiment, the tackifier layer (C) forms a PSA. The term “PSA” was previously defined in this disclosure.

The tackifier layer (C) may comprise other additives that serve different purposes. For instance, polystyrene reinforcing additives may be present. Moreover, other components can be added to improve the stability, impart structural reinforcement, improve coatability, or impart some other desirable properties. Accordingly, the tackifier layer (C) may include stabilizers which inhibit oxidative degradation of the adhesives and pigments.

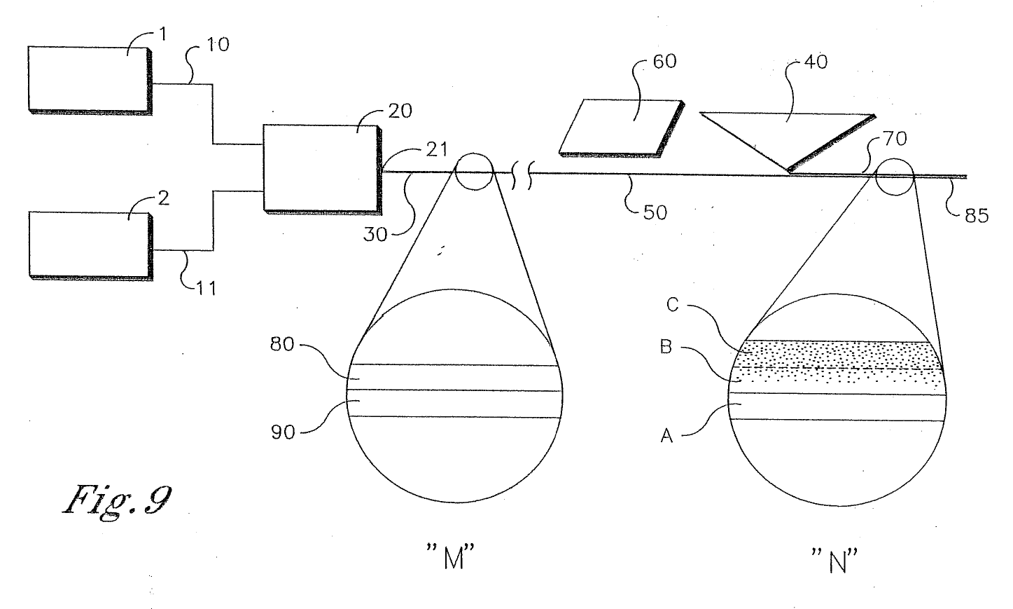

FIG. 9 represents a schematic overview of one embodiment of the process for preparing the PSA laminate according to the present invention. In a co-extrusion technique, two extruders 1 and 2 are utilized which provide two molten streams through lines 10 and 11 to the co-extrusion die 20. Extruder 1 provides a molten stream 10 of the adhesive base layer which comprises at least one adhesive base polymer and extruder 2 provides a molten stream 11 of the filmic outer layer comprising at least one filmic polymer. The extruders 1 and 2 are used to melt the polymers and pumps are provided to deliver the molten streams to the extrusion die 20. The precise extruder utilized is not critical to the process. A number of useful extruders are known, and these include, but are not limited to, single and twin-screw extruders, etc. Such extruders are available from a variety of commercial sources including Killion Extruders, Inc., C. W. Brabender, Inc., American Leistritz Extruder Corp., and Davis Standard Corp. A variety of useful co-extrusion die systems are known. Examples of extrusion dies useful in this invention are so-called “vane” dies, and multimanifold dies available from the Cloeren Company of Orange, Tex. Referring again to FIG. 9, the molten AB laminate 30 of at least two layers exits the extrusion die 20 through orifice 21. This AB laminate (as shown in detail M in FIG. 9) comprises the facestock layer 90 and the adhesive base layer 80 of the present invention.

It is understood by those skilled in the art of film coextrusion processes that actual production lines may have more than two extruders and may build up the AB laminate in more layers than are readily identified in the final AB laminate. In many cases, layers are build up of sublayers of the same or different material to enhance production speed, production flexibility or other reasons.

The AB laminate can then be further processed by any method known in the art. For instance, a number of additional steps can be performed on the AB laminate. The AB laminate of the present invention can either be collected for future processing, overlaminating and converting at a different time and/or geographic location, or these laminates can be routed to one or more other stations for printing, overlaminating, and/or converting during the same operation. In the example shown in FIG. 9, the AB laminate is coated by a coating head 40 forming a tackifier layer 70 of the tackifier composition on the adhesive base layer 80. It may be occasionally necessary to heat the AB laminate 50 before or after applying the tackifier layer (C). Thus, the presence of a heater 60 (e.g. infra-red heater) may be desirable. Note that heater 60 can be located after the application of the tackifier layer 70 by coating head 40. Once the tackifier layer 70 has been applied, the AB laminate will “convert” into the final product, the PSA laminate comprising facestock layer (A) and pressure sensitive adhesive layer (B and C) (as shown in detail N in FIG. 9) formed from the adhesive base layer 80 and tackifier layer 70, in a relatively short time (a few minutes to hours).

This PSA laminate can be further processed by printing and applying the laminate to a substrate. Alternatively, a liner may be combined with the PSA laminate if the PSA laminate shall be collected for later use.

The PSA laminate can be utilized to produce many articles of manufacture including, but not limited to, labels, decals, tapes, and films.

In one embodiment of the invention, a label is provided. The label comprises at least one PSA laminate. The label can be selected from paper labels, filmic labels, such as linerless filmic labels, or filmic labels with a release liner. Examples of filmic labels include, but are not limited to, packaging labels and specialty labels. Packaging labels include, but are not limited to labels used for packaging of beverages, food products, health and personal care products, pharmaceuticals, industrial chemicals, household chemicals or retail products. Speciality labels include, but are not limited to, repositionable labels, removable labels, washable labels, resealable labels, no-look labels, deep freezer labels and security labels.

The present invention particularly relates to the use of a washable PSA laminate that can be washed off from an article. More particularly, the use of filmic facestock in a washable PSA laminate for beverage labeling, from which the washable filmic laminate can be washed-off of returnable bottles for the beverage market, in conventional bottle washing machines.

One requirement for washable PSA laminates, suitable according to the present invention, is that the label laminate is completely removed from the bottle during the washing process in conventional bottle washing machines, under standard conditions. This consequently means that no adhesive residue is left on the bottle, as a result of adhesive transfer to the bottle, during the washing process.

A second requirement for washable PSA laminates, suitable according to the present invention, is that the adhesive layer does not de-bond from the filmic facestock (Layer A), during the washing process. Small parts of loose adhesives (so-called “stickies”) in the washing solutions are highly undesired as they may get trapped in bottle washing machines, possibly reducing the throughput.

A third requirement for filmic label laminates according to the present invention is that overall performance meets the criteria, required for beverage labeling in general, and exceeds, or at least equals, the overall performance of existing commercial filmic label laminates, relating to e.g. adhesion, appearance and convertibility.

The use of this washable PSA laminate according to the present invention offers unique properties regarding wash-off performance, where the washable PSA laminate can be completely removed from bottles in conventional bottle washing machines, during the washing process. These interactions are currently not completely understood.

Although not wishing to be bound by theory, the removal of washable PSA laminates from bottles is believed to be facilitated by a combination of factors. The elevated temperature induces a reduction in adhesion, i.e. peel strength. Furthermore, there is a slight tendency for label curling, induced by difference in the thermal expansion coefficients, of the adhesive base polymer and the tackifier layer, respectively. Label curling is possibly also facilitated by diffusion of low molecular weight tackifying resin components into the adhesive base polymer. This can cause the adhesive base polymer layer to swell, resulting in label edges are lifting from the bottle's surface. Complete physical removal of the filmic label is then facilitated by the turbulence, created by the water streams, and consequently the filmic PSA laminate is peeled off from the bottle's surface.

Washable PSA laminates according to the present invention can be washed-off completely in alkaline washing solutions present in conventional bottle washers known to the art.

In one embodiment of the invention, the washing solution contains 1 to 2 weight percentage of sodium hydroxide (NaOH) in (demineralized) water. The temperature of the washing solution can be above 50° C. or above 65° C.

Washable PSA laminates according to the present invention can be completely washed-off in the washing solution at a temperature from 70 to 80° C. within 10 minutes, within 5 minutes, or within 2 minutes.

In another embodiment of the invention, a tape is provided comprising the PSA laminate. Examples of tapes include, but are not limited to, multi-purpose tapes and specialty tapes. Multi-purpose tapes can be selected from the group consisting of packaging and transportation tapes; paint and spray masking tapes; consumer and office tapes; and bonding and fastening tapes. Specialty tapes can be selected from the group consisting of surface protection tapes; electrical insulation tapes; binding, reinforcing and marking tapes; splice tapes; HVAC-sealing tapes; medical application tapes; automotive applications tapes; electronic tapes; safety or reflective tapes; and diaper closure tapes.

In another embodiment of the invention, a film is provided comprising the PSA laminate. Such films include, but are not limited to, adhesive films, barrier films, protective films, and cling films. Adhesive films can be selected from the group consisting of pressure sensitive adhesive films, heat activated adhesive films, single and double-sided adhesive layers, carpet underlayment, roofing underlayment, clear or colored films, food contact adhesive films, and backing layer films. Backing layer films include, but are not limited to, backing layer films used to support a drug matrix, multi-purpose backing layer films, or substrate-specific backing layer films. Substrate-specific backing layer films include, but are not limited to, backing layer films for nonwovens, glass, paper, cotton, mineral wool, polyethylene, polypropylene, nylon, polyester, polyurethane foams/sheets, and acrylic adhesives.

Barrier films include, but are limited to, flexible food packaging; film barriers to odor, organic aromas and flavors, moisture, oxygen, and other gases; heat and impulse sealable barrier films, printable barrier films, corona treated barrier films, ostomy appliances, pharmaceutical blister packs, cap liners, bags, and textile lamination for protective clothing.

Protective films include, but are not limited to, films laminated to solid structures. Examples include, but are not limited to, protective films on corrugated steel pipe to improve corrosion and abrasion resistance, masking protective films for painted surfaces, reflective films for interior or exterior glass, anti-shatter films for window glass, and glass tinting films. The PSA can also be utilized in films that offer high optical clarity.

Cling films include, but are not limited to, food packaging, industrial applications, and consumer sealable applications. An example of industrial applications is pallet wrap.

Below are examples of the inventive PSA laminates. It should be understood that these are examples and do not limit the use of the inventive PSA to produce articles that are covered in this disclosure.

### EXAMPLES

The following test methods were utilized to determine the adhesive and wash-off performance of the washable filmic laminates illustrated in Examples 1 to 10.

180° Peel Adhesion was determined according to AFERA (European Association for the Self Adhesive Tape Industry) Test Method 5001.

Loop-tack was determined according to FINAT Test Method 9. FINAT is an organization for label converters and has its headquarters in The Hague, The Netherlands.

Shear cohesion was determined according to AFERA Test Method 5012.

All adhesive performance data are determined on stainless steel, if not mentioned otherwise.

Wash-of performance or washing performance was determined according to the following test method. Label laminates with dimensions 5 cm×7 cm were applied onto clean beer bottles in the machine direction. The cleanliness of the beer bottles was determined by visual inspection. Generally, standard tap water was used to clean bottles. In some cases, the beer bottles were cleaned with acetone. In cases where adhesive residue remained visible on the bottle, the bottles were subsequently rinsed with standard tap water. Beer bottles were immersed in (demineralized) water, containing sodium hydroxide (1.5 to 2 weight percentage) at a temperature of about 75 5° C.+/−5° C. The time in seconds until the filmic label was removed from the bottle was recorded and is a measure for washing performance.

For the determination of washing performance, the following beer bottles were utilized: a) Standard Euro Bottle; brown; 30 cL, returnable bottle, and b) Bittburger, brown, 33 cL, returnable bottle, Heineken; 25 cL, non-returnable bottle.

The following abbreviations denote the type of failure mode observed in the washing performance test method:
cr—clean removal
gh—ghosting (image of the label is observed on the bottle)
at—adhesive transfer (adhesive is transferred to the bottle)
ate—adhesive transfer near label edge (adhesive transfer only near the edges of the label)

The following abbreviations denote the type of failure mode observed while testing adhesive performance:
cf—cohesive failure
ss—slip stick
s—stringing
at—adhesive transfer
T—transfer of the tackifier layer to stainless steel

These failure modes described may have occurred over the full or part of the surface area bonded to the bottle substrate.

### Comparative Example 1

### Wash-Off Performance of Commercial Available Beer Bottles

In order to set a target value for washing performance under laboratory test conditions, commercially available beer bottles were immersed in the washing solution. Table 1 specifies the wash-off performance as obtained by the method previously described. It must be emphasized that the labels of the commercially available beer bottles are paper based, and the adhesive is wet-glue based.

TABLE 1
Washing performance of commercial available beer bottles.

Washing performance
(seconds)

| | | Backside |
|---|---|---|
| Beer bottle type¹⁾ | Front label | label |
| Heineken Standard Euro returnable | 120 | 150 |
| bottle 30 cL; brown | | |
| Heineken Standard Euro returnable | 300 | 440 |
| bottle 30 cL; brown | | |
| Heineken Standard Euro returnable | 125 | 270 |
| bottle 30 cL; brown | | |
| Heineken Standard Euro returnable | 70 | 220 |
| bottle 30 cL; brown | | |
| Heineken Standard Euro returnable | 165 | 80 |
| bottle 30 cL; brown | | |
| Heineken Standard Euro returnable | 90 | 80 |
| bottle 30 cL; brown | | |
| Bittburger bottle 33 cL; brown | 100 | 160 |
| Bittburger bottle 33 cL; brown | 60 | 110 |
| Bittburger bottle 33 cL; brown | 85 | 110 |

¹⁾The brand name Heineken and Bittburger denotes that the paper label is from Heineken and Bittburger, respectively. The Standard Euro returnable bottle is interchangeable with other beer brands.

The wash-off performance specified in Table 1 illustrates the variation in wash-off performance, as determined by the test method previously. The observed variation is commonly observed and can be probably due to variations in: 1) glass bottle surface quality, 2) label dispensing consistency, 3) storage conditions, and 4) experimental errors.

### Comparative Example 2

### Adhesive Performance of Commercial Available Clear Filmic Laminates

In order to set a target value for adhesive performance of commercial available clear filmic laminates, two existing clear filmic label laminates were tested for peel adhesion, loop tack and shear cohesion. The results are listed in Table 2.

TABLE 2
Adhesive performance of commercial available clear filmic
laminates.

| | 180° Peel | Loop tack | Shear cohesion |
|---|---|---|---|
| Filmic laminate | (N/25 mm) | (N/25 mm) | (min.) |
| Raflaclear¹⁾ | 5.0 | 11.0 | >10.000 |
| RI-708/60 TC3 | 10.4 | 17.7 | >10.000 |
| ASP5²⁾ | | | |

¹⁾Obtained from UPM Raflatac in Tamper Finland
²⁾Obtained from Ritrama S.p.A. in Caponago (Milano) Italy

### Example 3

### Preparation of a Tackier Composition

A tackifier composition (Layer C) was produced containing 10 wt % Kraton G1730 SEPS copolymer obtained from Kraton Polymers in Houston, Tex., 33.75 wt % Foral 85E hydrogenated rosin ester obtained from Eastman Chemical Company in Kingsport, Tenn., 33.75 wt % Regalite S5100 hydrocarbon resin from Eastman Chemical Company in Kingsport, Tenn., and 22.5% Primol 352 white oil obtained from ExxonMobil Chemical Company in Houston Tex. in a Z-blade mixer (Linden, Marienheide, Germany) with an effective volume of 1 L.

To meet the required initial fill levels of this equipment and to meet adopted best practice for this type of equipment with regards to polymer/tackifier ratio, initially a mixture containing 20% SBS polymer was prepared followed by a dilution to 10% polymer.

The Z-blade mixer was initially filled with 200 g Kraton G1730 and 100 g Foral 85E. The Z-blade mixing chamber was heated with an oil bath with a set-point of 170° C. to provide an internal temperature in the mixer of approximately 150° C. These components were mixed to a homogeneous product in about 60 minutes with regular removal of polymer and tackifier from the sides of the Z-blade mixer. To this mixture, 700 g of Foral 85E rosin ester were added in portions and mixed to a homogeneous product. 500 g of this polymer/tackifier mixture were removed, and a further 375 g Foral 85E rosin ester were added in portions. Then, 225 g Primol 352 white oil were added in portions and mixed to a homogeneous product to obtain 1000 g of Tackifier Composition 3.1. The tackifier composition was poured into a paper box coated with silicone release and cooled down to room temperature for further use.

### Inventive Example 4

### Preparation of Washable Filmic Laminates

Tackifier composition 3.1 prepared in Example 3 was coated at 13 gsm at 90° C. onto a silicon coated paper release liner using a slot die coater. Coating equipment (from Meltex, now Nordson in Luneburg, Germany) was operated at a line speed of about 20 m/min. Tackifier composition 3.1 was transferred to BOPP (packaging grade) with a caliper of about 30 μm. The lamination compression was set at 3 bar and the lamination temperature was about 40° C.

For producing the washable PSA laminate according to the present invention, a commercial AB laminate, Raflaclear, obtained from UPM Raflatac in Tampere, Finland, were cut into label sheets with dimensions of 200 mm by about 300 mm. The Raflaclear AB laminate contained BOPP (clear label grade) with a caliper of 50 μm, an acrylic adhesive polymer layer, and a silicon coated PET release liner. The coating weight of the acrylic adhesive polymer layer was about 9 gsm. The label sheets were delaminated from the silicon coated PET release liner. Washable PSA laminates were provided by transferring the tackifier composition 3.1 onto the acrylic adhesive polymer side of the Raflaclear AB laminate by manual feeding of the label sheets to the coater between the slot-die applicator and the lamination roll. The lamination compression was set at 3 bar, and the lamination temperature was about 40° C. to produce the washable PSA laminate. The washable filmic laminates were stored overnight in a climate control room at 23° C. and 50% relative humidity prior to testing.

The washable filmic laminateswere tested for peel adhesion, loop tack, shear cohesion and wash-off performance. The results are listed in Table 3.

TABLE 3
Results for peel adhesion, loop tack, shear cohesion and wash-
off performance on Standard Euro Bottles for Tackifier Composition 3.1.

| | Tackifier |
|---|---|
| | Composition |
| | 3.1 |
| Wash-off performance (3 days ageing) | 59 |
| (sec.) | |
| Wash-off performance (2 hrs at 65° C.) | 35 |
| (sec.) | |
| Peel adhesion (N/25 mm) | 5.0 |
| Loop tack (N/25 mm) | 11.3 |
| Shear cohesion (min.) | 1250 (T) |

### Example 5

### Effect of Tackifier Resin Type on Washable PSA Laminates

Tackifier compositions comprising a tackifier and an adhesive base polymer were prepared according to Example 3. The tackifier compositions differed with respect to the type of tackifier resin. Tackifier compositions contained 10 wt % Kraton D1152 SBScopolymer, 67.5 wt % tackifier resin and 22.5% Primol 352 white oil. The tackifier resins were a blend of Foral 85E rosin ester and Regalite S5100 hydrocarbon resin. The weight ratios are specified in Table 4.

Washable PSA laminates prepared according to Example 4 were tested for peel adhesion, loop tack, shear cohesion and wash-off performance. The coating weight of the acrylic adhesive base polymer was about 17 gsm. The results are listed in Table 4.

TABLE 4
Results for peel adhesion, loop tack, shear cohesion and wash-
off performance on Standard Euro Bottles for Different Tackifier
Compositions.

| | Example | Example | Example | Example |
|---|---|---|---|---|
| | 5.1 | 5.2 | 5.3 | 5.4 |
| wt % Foral 85E | 100 | 75 | 50 | 0 |
| wt % Regalite S5100 | 0 | 25 | 50 | 100 |
| Wash-off performance (3 | 45 | 60 | 95 | Permanent |
| days ageing) (sec.) | | | | |
| Wash-off performance | 37 | — | — | — |
| (2 hrs at 65° C.) (sec.) | | | | |
| Peel adhesion (N/25 mm) | 3 | 2.5 | 4.2 | 11 (T) |
| Loop tack (N/25 mm) | 6 | 5.2 | 8.2 | 37 (cf/st) |
| Shear cohesion (min.) | 500 (T) | 807 | 900 | 1650 (T) |

From Table 4, it can be seen that filmic label laminates containing 100% Regalite S5100 hydrocarbon resin have a permanent character. It can be concluded that polar types of tackifying resins improve the wash-off performance. The washable PSA laminate in Example 5.3 had the best balance between adhesive and wash-off performance.

### Example 6

### Effect of Type of Styrenic Block Copolymer

Tackifier compositions were prepared according to Example 3. The tackifier compositions differed with respect to the type of styrenic block copolymer used as the adhesive base polymer Tackifier compositions were prepared containing 10 wt % styrenic block copolymer (SBC), 67.5 wt % Foral 85E rosin ester, and 22.5 wt % Primol 352 white oil. The styrenic block copolymer are specified in Table 5.

The washable filmic laminates prepared according to Example 4 were tested for peel adhesion, loop tack, shear cohesion and wash-off performance. The coating weight of the acrylic adhesive base polymer was about 17 gsm. The results are listed in Table 5.

TABLE 5
Results for peel adhesion, loop tack, shear cohesion and wash-
off performance on Standard Euro Bottles for Different Adhesive Base
Polymers.

| | Example | Example | Example | Example |
|---|---|---|---|---|
| | 3.1 | 6.1 | 6.2 | 6.3 |
| Styrenic block copolymer | Kraton | Kraton | Kraton | Kraton |
| | D1152 | MD6455 | D1161 | G1730 |
| | (SBS) | (SIBS) | (SIS) | (SEPS) |
| Rubbery midblock | Butadiene | Isoprene/ | Isoprene | Ethylene/ |
| | | Butadiene | | Propylene |
| Wash-off performance (3 | 45 | 30 | 51 | 20 |
| days ageing) (sec.) | | | | |
| Wash-off performance | 37 | 42 | 34 | 20 |
| (2 hrs at 65° C.) (sec.) | | | | |
| Peel adhesion (N/25 mm) | 3 | 2.1 | 3.3 (st) | 5 (lcf) |
| Loop tack (N/25 mm) | 6 | 5.8 | 6.7 | 10 (lst) |
| Shear cohesion (min.) | 500 (T) | 400 (T) | 400 (T) | 600 (T) |

According to the data listed in Table 5, an adhesive base polymer containing a more aliphatic mid-block (ethylene/propylene versus butadiene) results in minor improvement in wash-off performance, whereas loop tack has increased significantly. From this, it can be concluded that there is no direct relation between adhesive performance on polar substrates, like stainless steel, determined at 23° C. and wash-off performance under the test conditions (75° C.+/−5° C.).

### Example 7

### Effect of Weight Percentage of Styrenic Block Copolymer in Washable PSA Laminates

Tackifier compositions were prepared according to Example 3. The tackifier compositions differed with respect to the weight fraction of styrenic block copolymer used as the adhesive base polymer. The tackifier compositions contained Kraton D1152 SBS copolymer, Foral 85E rosin ester, and Primol 352 white oil. The formulations are specified in Table 6.

The washable filmic laminates prepared according to Example 4 were tested for peel adhesion, loop tack, shear cohesion and wash-off performance. The coating weight of the acrylic adhesive base polymer was about 17 gsm. The results are listed in Table 6.

TABLE 6
Results for peel adhesion, loop tack, shear cohesion and wash-
off performance on Standard Euro Bottles for Tackifier Compositions
With Different Amounts of Adhesive Base Polymer.

| | Example | Example | Example |
|---|---|---|---|
| | 7.1 | 7.2 | 7.3 |
| wt % Kraton D1152 (SBS) | 10.0 | 20.0 | 40.0 |
| wt % Foral 85E | 67.5 | 60.0 | 45.0 |
| wt % Primol 352 | 22.5 | 20.0 | 15.0 |
| Wash-off performance | 45 | 68 | 86 |
| (3 days ageing) (sec.) | | | |
| Wash-off performance | 37 | — | 34 |
| (2 hrs at 65° C.) (sec.) | | | |
| Peel adhesion (N/25 mm) | 3 | 1.1 | 6.5 |
| Loop tack (N/25 mm) | 6 | 2.8 | 7.5 |
| Shear cohesion (min.) | 500 (T) | 765 (T) | 1500 (T) |

The weight percentage of Kraton D1152 SBScopolymer increased shear cohesion and did not affect wash-off performance significantly.

### Example 8

### Effect of Coating Weight of the Tackifier (Layer C) and Adhesive Base Layer (Layer B)

The washable filmic laminates prepared according to Example 4 were tested for peel adhesion, loop tack, shear cohesion and wash-off performance. Different coating weights of the acrylic adhesive base polymer (Layer B) and tackifier (Layer C) were applied. The coating weights are specified in Table 7.

TABLE 7
Results for peel adhesion, loop tack, shear cohesion and wash-
off performance on Standard Euro Bottles for Tackifier Composition of
Example 3.1.

| | Ex. | Ex. | Ex. | Ex. | Ex. | Ex. | Ex. |
|---|---|---|---|---|---|---|---|
| Filmic label laminate | 8.1 | 8.2 | 8.3¹ | 8.4 | 8.5 | 8.6 | 8.7 |
| Coating weight (gsm) | 17 | 17 | 17 | 9 | 9 | 0 | 0 |
| base polymer layer | | | | | | | |
| Coating weight (gsm) | 13 | 8 | 0 | 13 | 8 | 13 | 8 |
| tackifier top layer | | | | | | | |
| Wash-off performance | 45 | — | P²⁾ | 35 | 18 | 650 (T) | — |
| (3 days ageing) (sec.) | | | | | | | |
| Wash-off performance | 37 | — | P | 40 | 20 | PTC — | — |
| (2 hrs at 65° C.) (sec.) | | | | | | | |
| Peel adhesion (N/25 mm) | 3 | 1.3 (gh) | 5 | 4.5 (cf + | 1.5 (gh) | 9.4 (cf) | 8.2 (cf) |
| | | | | st + T) | | | |
| Loop tack (N/25 mm) | 6 | 3.3 (gh) | 11 | 9.8 | 4.6 (gh) | 19.7 (cf + | 16.5 (cf) |
| | | | | | | st) | |
| Shear cohesion (min.) | 500 (T) | 850 (T) | >10.000 | 300 (T) | 550 (T) | 450 (T) | 40 (cf) |

¹Raflaclear reference
²⁾P is permanent label

Table 7 clearly demonstrates the need for both an adhesive base polymer layer and a tackifier layer. All washable filmic laminates exhibited good washing performance, except laminates in Examples 8.3 and 8.6. In Example 8.3, there was no tackifier layer, and in Example 8.6, there was no adhesive base polymer layer.

### Example 9

### Effect of Filmic Facestock Material

The tackifier composition of Example 7.3 was prepared according to Example 3. The tackifier composition contained 40 wt % Kraton D1152 SBS copolymer, 45 wt % Foral 85E rosin ester, and 15 wt % Primol 352 white oil. Mylar with a caliper of 40 [symbol] m was used as filmic facestock material. Acronal V215 (obtained from BASF AG, Ludwigshafen, Germany) was coated at 15 gsm (dry weight), using a Mayer-bar (no. 4) on a manually operated hand-coater. The wet tackifier composition was dried at 100° C. for 1 minute.

The washable filmic laminates prepared according to Example 4 were tested for peel adhesion, loop tack, shear cohesion and wash-off performance. The results are listed in Table 8.

TABLE 8
Results for peel adhesion, loop tack, shear cohesion and wash-
off performance on Standard Euro Bottles for Example 7.3.

| | BOPP | |
|---|---|---|
| | (50 □ m) | Mylar (40 □ m) |
| Wash-off performance (3 days ageing) | 86 | 75 |
| (sec.) | | |
| Wash-off performance (2 hrs at 65° C.) | 34 | 140 |
| (sec.) | | |
| Peel adhesion (N/25 mm) | 6.5 | — |
| Loop tack (N/25 mm) | 7.5 | — |
| Shear cohesion (min.) | 1500 (T) | — |

The results in Table 8 indicate that wash-off performance was not dependent on the type of filmic facestock material.

### Example 10

### Prophetic or Theoretical Example—Water Based Tackifier (Layer C)

100 parts of the tackifier composition of Example 6.3 are mixed with 5 parts of Parmolyn 100 FGK, as emulsifier, and is heated to 90° C. 2.9 parts of KOH (50% by weight) are added, so that the final tackifier composition has a pH of 9. Water with a temperature of 90° C. is slowly added to the viscous blend until inversion is reached. The emulsion is further diluted until the dry weight of the emulsion is about 50% by weight. A tackifier dispersion is obtained, having a mean particle size of about 250 nm (Coulter LS60 particle sizing equipment) and a Brookfield viscosity of 500 mPa·s (spindle no. 2 at 60 rpm).

The tackifier dispersion is coated at 17 gsm (dry weight), using a Mayer-bar (no. 4) on a manually operated hand-coater. The wet tackifier dispersion is dried at 100° C. for 1 minute.

The filmic label laminates is prepared according to Example 4 [0061] and are tested for peel adhesion, loop tack, shear cohesion and wash-off performance.

### Example 11

### Use of Simple Rosin Esters in Washable PSA Laminates

Tackifier compositions were prepared according to Example 3. The tackifier compositions differed with respect to type of rosin tackifier used. The tackifier compositions contained Kraton D1152 SBS copolymer or Kraton D1161 SIS copolymer, simple rosin esters Permalyn 5095 (glycerol ester of rosin) or Permalyn 5110 (pentaerithrytol ester of rosin) in combination with Regalite S5100 hydrocarbon resin, and Primol 352 white oil. The formulations are specified in Table 9.

The washable PSA laminates prepared according to Example 4 were tested for wash-off performance. The coating weight of the acrylic adhesive base polymer was about 9 gsm. The results are listed in Table 9.

TABLE 9
Results for peel adhesion, loop tack, shear cohesion and wash-
off performance on Standard Euro Bottles for Tackifier Compositions
With Different Amounts of Adhesive Base Polymer.

| | Example | Example |
|---|---|---|
| | 11.1 | 11.2 |
| wt % Kraton D1152 (SBS) | 10.0 | |
| wt % Kraton D1161 (SIS) | | 10.0 |
| wt % Permalyn 5095 (glycerol ester | 67.5 | |
| of rosin) | | |
| wt % Permalyn 5110 (penta ester of | | 33.75 |
| rosin) | | |
| wt % Regalite S5100 | | 33.75 |
| wt % Primol 352 | 22.5 | 22.5 |
| Wash-off performance | 104 | 283 |
| (3 days ageing) (sec.) | | |

Clearly, tackifier compositions with adequate wash-off performance can be based on simple rosins as well.

That which is claimed is:

1. A process for removing a washable PSA laminate from a substrate comprising contacting said washable PSA laminate with water and optionally, a base, to remove said washable PSA laminate from said substrate; wherein said washable PSA laminate comprises at least one facestock layer, at least one adhesive base layer, and at least one tackifier layer; wherein said facestock layer comprises at least one filmic facestock material; wherein said adhesive base layer comprises at least one adhesive base polymer; wherein said tackifier layer comprises at least one tackifier and optionally at least one adhesive base polymer; wherein said tackifier layer is applied to the adhesive base layer side of the washable PSA laminate.

2. The process for removing a washable PSA laminate according to claim 1 wherein said washable PSA laminate further comprises at least one layer selected from the group consisting of at least one barrier layer, at least one overlaminate layer, at least one release liner, at least one tie layer, and at least one primer layer.

3. The process for removing a washable PSA laminate wherein said filmic facestock material is a filmic polymer, a blend of filmic polymers, or a multi-layer film of various filmic polymers.

4. The process for removing a washable PSA laminate according to claim 3 wherein said filmic polymer has a solubility parameter that is inconsistent with or incompatible with said adhesive base polymer to prevent migration between said facestock layer and said adhesive base layer.

5. The process for removing a washable PSA laminate according to claim 3 wherein said filmic polymer is selected from the group consisting of polystyrenes, polyolefins, polyamides, polyesters, polycarbonates, polyurethanes, polyacrylates, polyvinyl alcohols, polyesters, functional polyesters, poly(ethylene vinyl alcohols), polyether block polyamides, polyvinyl acetates, and mixtures thereof.

6. The process for removing a washable PSA laminate according to claim 3 wherein said filmic polymer is a polyolefin having repeating units selected from the group consisting of ethylene, propylene, and 1-butene.

7. The process for removing a washable PSA laminate according to claim 3 wherein said filmic polymer is at least one selected from the group consisting of polyethylene, polypropylene and ethylene-propylene copolymer.

8. The process for removing a washable PSA laminate according to claim 1 wherein said adhesive base polymer is at least one selected from the group consisting of at least one random copolymer adhesive base material, at least one block copolymer adhesive base polymer, and at least one natural or synthetic rubber.

9. The process for removing a washable PSA laminate according to claim 8 wherein said random copolymer adhesive base material is selected from the group consisting of copolymers based upon acrylate and/or methacrylate copolymers and their derivatives, α-olefin copolymers, silicone-copolymers, and chloroprene/acrylonitrile copolymers.

10. The process for removing a washable PSA laminate according to claim 8 wherein said block copolymer adhesive base polymer is selected from the group consisting of linear block copolymers, branched block copolymers, di-block copolymers, tri-block copolymers, tetra-block copolymers, multi-block copolymers, star block copolymers, grafted, and radial block copolymers.

11. The process for removing a washable PSA laminate according to claim 10 wherein said natural or synthetic rubber is selected from the group consisting of polyisobutylene, polyisoprene, and butyl rubber.

12. The process for removing a washable PSA laminate according to claim 1 wherein said adhesive base polymer comprises at least one thermoplastic elastomer (TPE).

13. The process for removing a washable PSA laminate according to claim 9 wherein said copolymers based upon acrylate and/or methacrylate copolymers are selected from the group consisting of 2-ethyl hexyl acrylate, butyl acrylate, methyl (meta)acrylate, acrylic acid, styrene, and mixtures thereof.

14. The process for removing a washable PSA laminate according to claim 1 wherein tri-block polymers, tetra-block polymers, and multi-block polymers are selected from the group consisting of styrene-butadiene-styrene (SBS), styrene-isoprene-styrene (SIS), α-methylstyrene-butadiene-α-methylstyrene, α-methylstyrene-isoprene-α-methylstyrene, styrene-isoprene-butadiene-styrene (SIBS), styrene-ethylene/propylene-styrene (SEPS), styrene-ethylene/propylene (SEP)ₓ, and derivatives thereof.

15. The process for removing a washable PSA laminate according to claim 1 according to claim 1 wherein said tackifier is at least one selected from the group consisting of rosin-based and hydrogenated rosin-based tackifiers, hydrocarbon-based and hydrogenated hydrocarbon-based tackifiers, phenolic-based tackifiers, terpene-based tackifiers, terpene phenolic-based tackifiers, styrenated terpene-based tackifiers, hydrogenated terpene-based tackifiers, polyester-based tackifiers, pure monomer aromatic-based tackifiers, aromatic acrylic-based tackifiers, liquid resin type tackifiers, functionalized type tackifiers, and hydrogenated derivatives and mixtures thereof.

16. The process for removing a washable PSA laminate according to claim 1 wherein said base is about a 1 wt % to about a 2 wt % alkaline solution.

17. The process for removing a washable PSA laminate according to claim 1 wherein said temperature is 50° C. or greater.

18. The process for removing a washable PSA laminate according to claim 1 wherein said washable PSA laminate is removed in 10 minutes or less.

19. The process for removing a washable PSA laminate according to claim 1 wherein said washable PSA laminate comprises: a) at least one facestock layer selected from the group consisting of polyethylene or polypropylene; b) at least one adhesive base layer comprising at least one adhesive base polymer selected from the group consisting 2-ethyl hexyl acrylate, butyl acrylate, methyl (meta)acrylate, acrylic acid, styrene, and mixtures thereof; and c) at least one tackifier layer comprising at least one tackifier and at least one hydrocarbon resin; and wherein said tackifier is selected from the group consisting of rosin esters and hydrogenated rosin esters.

20. The process for removing a washable PSA laminate according to claim 1 wherein said substrate is a bottle.
